(19) United States
(12) Patent Application Publication
(10) Pub. No.: US 2025/0118793 A1
(43) Pub. Date: Apr. 10, 2025

(54) METHOD FOR MANUFACTURING LITHIUM-ION BATTERY AND LITHIUM-ION BATTERY

(71) Applicant: TOYOTA JIDOSHA KABUSHIKI KAISHA, Toyota-shi (JP)

(72) Inventor: Daichi KOSAKA, Toyota-shi (JP)

(73) Assignee: TOYOTA JIDOSHA KABUSHIKI KAISHA, Toyota-shi (JP)

(21) Appl. No.: 18/884,142

(22) Filed: Sep. 13, 2024

(30) Foreign Application Priority Data
Oct. 6, 2023 (JP) 2023-174278

(51) Int. Cl. H01M 10/0525; H01M 4/02; H01M 4/04; H01M 4/131; H01M 4/1391; H01M 4/525; H01M 4/62; H01M 10/058; H01M 10/42; H01M 10/44

(52) U.S. Cl. CPC H01M 10/0525; H01M 4/0445; H01M 4/131; H01M 4/1391; H01M 4/525; H01M 4/62; H01M 10/058; H01M 10/4235; H01M 10/44; H01M 2004/028

(57) ABSTRACT

The method of the present disclosure for producing a lithium-ion battery includes providing a positive electrode precursor layer containing at least lithium alloy particles and a positive electrode active material, obtaining a lithium-ion battery precursor having the positive electrode precursor layer, the separator layer, and the negative electrode active material layer in an order of the positive electrode precursor layer, the separator layer, and the negative electrode active material layer and impregnated with an electrolyte solution, and performing initial charging on the lithium-ion battery precursor to make the positive electrode precursor layer a positive electrode active material layer, wherein the lithium alloy particle is a lithium alloy particle with a lithium-alloying potential of 0.5 V (vsLi/Li⁺) or higher, and with a particle diameter D90 smaller than 70 μm as measured by a laser diffraction and scattering method.

### CROSS-REFERENCE TO RELATED APPLICATION

This application claims priority to Japanese Patent Application No. 2023-174278 filed on Oct. 6, 2023, incorporated herein by reference in its entirety.

### BACKGROUND

### 1. Technical Field

The present disclosure relates to a method for manufacturing a lithium-ion battery and a lithium-ion battery.

### 2. Description of Related Art

Conventionally, active materials for lithium-ion batteries have been improved to increase capacity.

Japanese Unexamined Patent Application Publication No. 2014-010991 (JP 2014-010991 A) discloses an electrode for use in a non-aqueous electrolyte secondary battery. The specific surface area of a negative electrode active material of the electrode, measured by the N₂ adsorption method, is 3.3 m²/g or more and 4.4 m²/g or less. The dibutyl phthalate (DBP) oil absorption of a positive electrode active material of the electrode is 30 ml/100 g or more and 47 ml/100 g or less. The positive electrode density is 1.8 g/cm³ or more and 2.2 g/cm³ or less. JP 2014-010991 A discloses that the capacity of the negative electrode is increased by using a lithium (Li) alloy as an active material.

Lithium nickel cobalt manganese (NCM) oxide is widely used as a positive electrode active material, and an improvement in composition of the lithium NCM oxide has been studied.

### SUMMARY

When conventional electrodes such as the electrode of JP 2014-010991 A are used, a significant decrease in capacity is sometimes observed after initial charging. In addition, in batteries, it is also required to have good cycle characteristics, that is, to suppress a decrease in capacity in a case where charging and discharging are repeatedly performed.

Therefore, the present disclosure provides a novel method for manufacturing a lithium-ion battery, and a lithium-ion battery that can suppress a decrease in capacity in a case where charging and discharging are repeatedly performed while suppressing a decrease in capacity after initial charging.

The inventors of the present disclosure have found through intensive studies that the above issue could be solved by the following means, and have completed the present disclosure. The present disclosure is as follows.

<First Aspect> A method for manufacturing a lithium-ion battery includes: providing a positive electrode precursor layer containing at least a lithium alloy particle and a positive electrode active material;
providing a lithium-ion battery precursor including the positive electrode precursor layer, a separator layer, and a negative electrode active material layer in an order of the positive electrode precursor layer, the separator layer, and the negative electrode active material layer and impregnated with an electrolyte; and
performing initial charging on the lithium-ion battery precursor to make the positive electrode precursor layer into a positive electrode active material layer. In the method, the lithium alloy particle is a lithium alloy particle with a lithium-alloying potential of 0.5 V (vsLi/Li⁺) or higher, and with a particle diameter D90 smaller than 70 μm as measured by a laser diffraction and scattering method.
   <Second Aspect> In method according to First Aspect, the lithium alloy particle is selected from the group consisting of Li₃Bi, Li₃Sb, and LiSn.
   <Third Aspect> In the method according to First Aspect or Second Aspect, the positive electrode active material is lithium nickel cobalt manganese oxide.
   <Fourth Aspect> A lithium-ion battery includes a positive electrode active material layer, a separator layer, and a negative electrode active material layer in an order of the positive electrode active material layer, the separator layer, and the negative electrode active material layer. In the lithium-ion battery,
the positive electrode active material layer contains at least one of a positive electrode active material, a bismuth elemental particle, and an antimony elemental particle, and
a particle diameter D90 of the bismuth elemental particle and a particle diameter D90 of the antimony elemental particle measured by a laser diffraction and scattering method are each smaller than 70 μm.

According to the present disclosure, it is possible to provide a novel method for manufacturing a lithium-ion battery, and a lithium-ion battery that can suppress a decrease in capacity in a case where charging and discharging are repeatedly performed while suppressing a decrease in capacity after initial charging.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of a lithium-ion battery of the present disclosure.

### DETAILED DESCRIPTION OF EMBODIMENTS

### Method for Manufacturing Lithium-Ion Battery

A method of manufacturing a lithium-ion battery of present disclosure includes:
providing a positive electrode precursor layer containing at least lithium alloy particles and a positive electrode active material;
obtaining a lithium-ion battery precursor including a positive electrode precursor layer, a separator layer, and a negative electrode active material layer in an order of the positive electrode precursor layer, the separator layer, and the negative electrode active material layer and impregnated with an electrolyte; and
performing initial charging on the lithium-ion battery precursor to make the positive electrode precursor layer into a positive electrode active material layer.

The lithium alloy particles have a lithium-alloying potential of 0.5 V (vsLi/Li⁺), and have a D90 smaller than 70 μm as measured by a laser diffraction and scattering method.

The inventors of the present disclosure have found that the reason for the decrease in the battery capacity described in JP 2014-010991 A is that Li supplied in the initial positive electrode active material is consumed in order to form Solid Electrolyte Interphase (SEI) in the negative electrode during the initial charge.

In contrast, the inventors of the present disclosure have found that the capacity can be improved by obtaining a lithium-ion battery using the above-described positive electrode precursor layer. Without wishing to be bound by theory, it is believed that this is because lithium in the lithium alloy particles in the positive electrode precursor layers is released during the initial charge and becomes lithium consumed for forming SEI in the negative electrode, so that lithium in the positive electrode active material can be suppressed from being consumed for forming SEI. In addition, it is considered that when the lithium-alloying potential of the lithium alloy particles is equal to or higher than 0.5 V (vsLi/Li⁺), it is possible to prevent an electrochemical reaction from occurring inside the positive electrode precursors before the initial charge.

On the other hand, when the lithium alloy particles are used, there is a problem that the cycle characteristics are not good, and when repeated charging and discharging are performed, the capacity may be greatly reduced by the number of times of small charging and discharging. The present inventors have found that the cause is that the metal constituting the lithium alloy particles becomes locally high concentration of metal ions when oxidized and dissolved at the time of charging, it is concentrated precipitated at one place in the negative electrode, this is the point of resistance.

On the other hand, the present inventors have found that by using lithium alloy particles having a D90 of 70 μm, concentrated precipitation of metals in the negative electrode can be suppressed, thereby solving the above problem.

Hereinafter, each component of the present disclosure will be described.

### Preparation of Positive Electrode Precursor Layer

The positive electrode precursor layer contains at least the lithium alloy particles having a lithium-alloying potential of 0.5 V (vsLi/Li⁺) or higher and the positive electrode active material. The positive electrode precursor layer may also contain other optional materials. Other materials include, for example, conductive auxiliaries and binders.

Preparation of the positive electrode precursor layer can be performed by mixing each material constituting this and coating.

### Lithium Alloy Particle

The lithium alloy particles have a lithium-alloying potential of 0.5 V (vsLi/Li⁺) and has a D90 of not more than 70 μm.

The lithium-alloying potential of the lithium alloy particles may be greater than or equal to 0.6 V (vsLi/Li⁺), greater than or equal to 0.7 V (vsLi/Li⁺), or greater than or equal to 0.8 V (vsLi/Li⁺). The lithium-alloying potential of the lithium alloy particles may also be smaller than or equal to 1.5 V (vsLi/Li⁺), smaller than or equal to 1.4 V (vsLi/Li⁺), smaller than or equal to 1.3 V (vsLi/Li⁺), smaller than or equal to 1.2 V (vsLi/Li⁺), smaller than or equal to 1.1 V (vsLi/Li⁺), or smaller than or equal to 1.0 V (vsLi/Li⁺).

Here, the lithium-alloying potential (vsLi/Li⁺) is the electrode potential of the electrode reaction of the formula (1) and is expressed with reference to the electrode potential of the lithium of the formula (2) below:

xLi⁺+M+xe⁻←→LiₓM (1)

Li⁺+e⁻←→Li (2)

The lithium-alloying potential (vsLi/Li⁺) can be measured as a unipolar potential obtained when the alloy is immersed in a salt solution of lithium.

D90 of the lithium alloy particles is 70 μm or less. D90 may be 65 μm or less, 60 μm or less, 55 μm or less, 50 μm or less, 45 μm or less, 40 μm or less, 35 μm or less, 30 μm or less, 25 μm or less, or 20 μm or less. D90 may be greater than or equal to 5 μm, greater than or equal to 10 μm, or greater than or equal to 15 μm.

The particles having such a D90 can be obtained, for example, by passing the lithium alloy particles through a sieve having a pore size within the above-described range.

D50 of lithium alloy particles is not particularly limited as long as the above D90 is satisfied, for example, 1 μm or more, 3 μm or more, 5 μm or more, or 7 μm or more, also 60 μm or less, 55 μm or less, or 50 μm or less.

D90 and D50 refer to a particle diameter (D90 diameter) at an integrated value of 90% and a particle diameter (D50 diameter) at an integrated value of 50% in a volume-based particle size distribution determined by a laser diffraction and scattering method, respectively.

For example, Li₃Bi, Li₃Sb, and LiSn can be used as such lithium alloy particles.

### Positive Electrode Active Material

An optional positive electrode active material can be used as the positive electrode active material, and is not particularly limited, and for example, a lithium-containing oxide can be used.

The lithium-containing oxide as the positive electrode active material is not particularly limited, and may include, for example, at least: at least one transition-metal element selected from Li, Co, Ni and Mn; and O. As such a lithium-containing oxide, for example, lithium cobaltate (LiCoO₂), lithium nickelate (LiNiO₂), lithium manganate (LiMn₂O₄), and a lithium nickel cobalt manganese (NCM) oxide in which some of these elements are replaced with other elements can be used. The lithium NCM oxide is generally represented by the general formula LiₐMnₓNi_{y}Co_{z}O_{2±δ} (0<a≤1.5, 0≤x≤1.5, 0≤y≤1.5, 0≤z≤1.5, 0<δ (=x+y+z)<1.5), and, for example, LiNi_{0.8}Co_{0.1}Mn_{0.1}O₂ (NCM811) or the like can be used. The lithium-containing oxide as the positive electrode active material may have, for example, an O₂ type structure, an O₃ type structure, or a crystalline structure other than these. As the positive electrode active material, only one kind may be used alone, or two or more kinds may be used in combination.

### Conductive Aid

As the conductive auxiliary agent optionally contained in the positive electrode precursor layer, one known as a conductive auxiliary agent used in a lithium-ion battery may be used. Specifically, a carbon material such as Ketjen Black (KB), a vapor-grown carbon fiber (VGCF), acetylene black (AB), carbon nanotubes (CNT), carbon nanofibers (CNF), carbon black, coke, graphite, or the like may be used. Alternatively, a metal material capable of withstanding the environment when the battery is used may also be used. As the conductive auxiliary agent, only one kind may be used alone, or a combination of two or more kinds may be used. The shape of the conductive aid may be various shapes such as powdery, fibrous, and the like. The amount of the conductive auxiliary agent contained in the positive electrode active material layer is not particularly limited.

### Binder

As the binder optionally contained in the positive electrode precursor layer, a binder known as a binder used in a lithium-ion battery may be used. For example, a styrene butadiene rubber (SBR)-based binder, a carboxymethyl cellulose (CMC)-based binder, an acrylonitrile butadiene rubber (ABR)-based binder, a butadiene rubber (BR)-based binder, a polyvinylidene fluoride (PVDF)-based binder, a polytetrafluoroethylene (PTFE)-based binder, and the like may be used. Only one binder may be used alone, or a combination of two or more binders may be used. The amount of the binder contained in the positive electrode active material layer is not particularly limited.

### Preparation of Lithium-Ion Battery Precursor

The lithium-ion battery precursor has a positive electrode precursor layer, a separator layer, and a negative electrode active material layer in an order of the positive electrode precursor layer, the separator layer, and the negative electrode active material layer, and is impregnated with a non-aqueous electrolyte solution. The preparation of the lithium-ion battery precursor may be performed by a known method.

The lithium-ion battery precursor may further include a positive electrode current collector layer and a negative electrode current collector layer.

Hereinafter, each component of the lithium-ion battery precursor will be described.

### Positive Electrode Current Collector Layer

The positive electrode current collector layer may be formed of a known metal or the like that can be used as a positive electrode current collector of a lithium-ion battery. Examples of such metals include metal materials containing at least one element selected from the group consisting of Cu, Ni, Al, V, Au, Pt, Mg, Fe, Ti, Pb, Co, Cr, Zn, Ge, In, Sn, and Zr. The form of the positive electrode current collector is not particularly limited. Various forms such as foil, mesh, porous, and the like may be employed. The metal may be deposited and plated on the surface of the substrate.

### Separator

As the separator, a separator known as a separator used in a lithium-ion battery may be used. For example, the separator may be made of a resin such as polyethylene (PE), polypropylene (PP), polyester, and polyamide. The separator may have a single-layer structure or a multi-layer structure. As the separator having a multilayer structure, for example, a separator having a multilayer structure composed of the above resin, for example, a separator having a PE/PP two-layer structure, a separator having a PP/PE/PP or PE/PP/PE three-layer structure, or the like can be used. The separator may be composed of a nonwoven fabric such as a cellulose nonwoven fabric, a resin nonwoven fabric, or a glass fiber nonwoven fabric. The thickness of the separator is not particularly limited, and may be, for example, 5 μm or more and 1 mm or less.

### Negative Electrode Active Material Layer

The negative electrode active material layer contains a negative electrode active material. The negative electrode active material layer may contain other optional components. Examples of the other components include a conductive auxiliary agent and a binder. As the conductive assistant and the binder, reference can be made to the description of the positive electrode active material layer.

### Negative Electrode Active Material Layer: Negative Electrode Active Material

As the negative electrode active material, various materials having a potential (charge-discharge potential) at which ions are occluded and released, which is a lower potential than the positive electrode active material described above, may be used. As the negative electrode active material, for example, a silicon-based active material such as Si, an Si alloy, or silicon oxide; a carbon-based active material such as black lead, graphite, or hard carbon; various oxide-based active materials such as lithium titanate; and a metallic lithium or a lithium alloy may be used. Only one type of the negative electrode active material may be used alone, or two or more types may be used in combination.

### Negative Electrode Current Collector Layer

The negative electrode current collector layer may be formed of a known metal or the like that can be used as a negative electrode current collector of a lithium-ion battery. Such a metal may be, for example, a metal material containing at least one element selected from the group consisting of Cu, Ni, Al, V, Au, Pt, Mg, Fe, Ti, Pb, Co, Cr, Zn, Ge, In, Sn, and Zr. The form of the negative electrode current collector layer is not particularly limited, and may be various forms such as a foil form, a mesh form, and a porous form. The negative electrode current collector layer may be formed by plating or depositing the metal on the surface of a substrate made of an optional material. The surface of the negative electrode current collector layer may be coated with a carbon material or the like.

### Non-Aqueous Electrolyte

The non-aqueous electrolyte may contain a non-aqueous solvent and an electrolyte. The electrolytic solution may contain an alkali metal ion as a carrier ion, for example, a lithium-ion.

As the non-aqueous solvent, a solvent other than water, for example, an organic solvent can be used. As the organic solvent, for example, a carbonate-based solvent such as ethylene carbonate (EC), dimethyl carbonate (DMC), ethyl methyl carbonate (EMC), or fluoroethylene carbonate (FEC) can be used. These organic solvents may be used singly or in combination.

The electrolyte is not particularly limited, and may be, for example, a lithium salt. For example, LiPF₆ can be used as the lithium-salt.

### Preparation of Positive Electrode Active Material Layer

The positive electrode active material layer is prepared by performing initial charging on the lithium-ion battery precursor and forming the positive electrode precursor layer into a positive electrode active material layer.

When the lithium-ion battery precursor having the positive electrode layer precursor layer is initially charged, lithium of the lithium alloy particles is consumed for forming SEI in the negative electrode. Consequently, when the lithium alloy particles contain at least one of Li₃Bi and Li₃Sb, the resulting positive electrode active material layers contain at least one of bismuth elemental particles and antimony elemental particles.

The initial charging condition may be a known condition.

### Lithium-Ion Battery

The lithium-ion battery of the present disclosure includes:
a positive electrode active material layer, a separator layer, and a negative electrode active material layer;
the positive electrode active material layer contains at least one of a positive electrode active material, a bismuth elemental particle, and an antimony elemental particle; and
D90 of the bismuth elemental particles and the antimony elemental particles measured by a laser diffraction and scattering method is smaller than 70 μm.

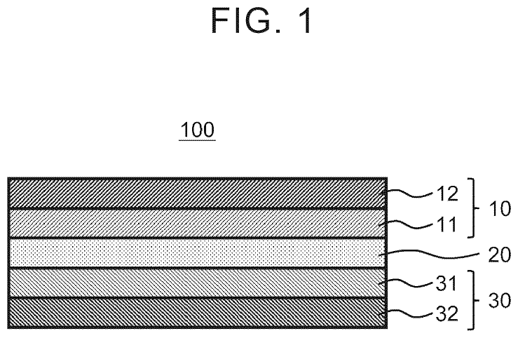

FIG. 1 schematically illustrates a configuration of a lithium-ion battery 100 according to one embodiment of the present disclosure. As illustrated in FIG. 1, the lithium-ion battery 100 may include a positive electrode 10, a separator 20, and a negative electrode 30. The positive electrode 10 may include the positive electrode active material layer 11 and the positive electrode current collector layer 12, and the negative electrode 30 may include the negative electrode active material layer 31 and the negative electrode current collector layer 32. In this case, the positive electrode active material layer 11 may include the above-described positive electrode active material. The electrolyte may be included in the positive electrode active material layer 11 and the negative electrode active material layer 31, although not shown.

In addition, the bismuth elemental particle and the antimony elemental particle are formed by desorption of lithium having a small atomic weight from the above-described lithium alloy particles. Therefore, it is believed that the particle size of these particles is comparable to or slightly smaller than that of the lithium alloy particles before the reaction. It is therefore believed that D90 and D50 of these particles are also comparable to or slightly smaller than the pre-reaction lithium alloy particles.

In view of the above, D90 and D50 of the bismuth elemental particles and the antimony elemental particles can be referred to the description of the lithium alloy particles.

For each configuration of the lithium-ion battery, the description of the manufacturing method can be referred to.

The present disclosure will be described in detail with reference to Examples and Comparative Examples, but the present disclosure is not limited thereto.

### Preparation of Lithium-Ion Battery

### Example 1

Li₃Bi powder as lithium alloy particles was sieved through a 60 μm sieve. D90 and D50 of Li₃Bi powder passed through a sieve were measured by laser diffraction and scattering method.

92.3 mg of LiNi_{0.8}Co_{0.1}Mn_{0.1}O₂ (NCM811) as a positive electrode active material, 8.4 mg of the above Li₃Bi powder as lithium alloy particles, conductivity aid, and binder were mixed in a NMP to form a slurry. This was applied to an Al foil and dried to obtain positive electrode precursor layers.

The obtained positive electrode precursor layer was opposed to a negative electrode active material layer containing graphite as an active material via a separator layer, vacuum-dried, and a non-aqueous electrolyte solution was put in to obtain a lithium-ion battery precursor.

### Example 2 to 9 and Reference Example 1 to 6

Lithium-ion battery precursors of Examples 2 to 9 and Reference Examples 1 to 3 were obtained in the same manner as in Example 1, except that the content of the positive electrode active material and the type, preparation conditions, and content of the lithium alloy particles were changed as shown in Table 1. The “60 and 20” in Table 1 means that the material that passed the 60 μm sieve was further subjected to a 20 μm sieve, and the material that did not pass the 20 μm sieve was used.

### Evaluation

### Battery Capacity During Initial Charging and Discharging

A current value that becomes a 210 mA/g is defined as a 1 C rate based on the mass of the positive electrode active material contained in the cell, a 0.2 C is defined as a charging and discharging current value, and a 0.03 C is defined as a termination current value, so that CCCV charge and CCCV discharge are performed. The upper voltage limit for charging is 4.25 V and the lower voltage limit for discharging is 2.50 V. The obtained CCCV discharging capacity is defined as the capacity of the cell, and is used as the evaluation index of the present disclosure.

### Cycle Characteristics

After measuring the capacity of the cell, a cycle test (CC charge and CC discharge, upper and lower limit voltage 3 V to 4.25 V and 0.3 C rate) was performed to determine the number of cycles until CC discharge capacity became 40% or less of the initial discharge capacity.

The configurations and the evaluations of the examples and comparative examples are shown in Table 1.

TABLE 1

| | Configuration | | | | | | | | | | | | |
|---|---|---|---|---|---|---|---|---|---|---|---|---|---|
| | | | Lithium alloy particles | | | | | | | | Evaluation results | | |
| | Positive | | | | | | Adjustment | | | | | | Number |
| | electrode | | | | | | conditions | | | | Battery | | of cycles |
| | active material | | | Alloying | | | (Sieve | Particle | | Total | capacity | | up to |
| | Content | Volume | | potential | Content | Volume | diameter | size (μm) | | volume | Charging | Discharge | capacity |
| | (mg) | (cc) | Type | (V) | (mg) | (cc) | (μm)) | D90 | D50 | (cc) | (mAh) | (mAh) | retention <40% |
| Reference | 92.3 | 0.0200 | Li [symbol] Bi | 0.81 to | 8.4 | 0.0017 | 100 | 102 | 49 | 0.0217 | 25.0 | 22.1 | 26 |
| Example 1 | | | | 0.83 | | | | | | | | | |
| Reference | 92.8 | 0.0202 | Li [symbol] Sb | 0.94 to | 5.2 | 0.0015 | 100 | 107 | 51 | 0.0217 | 25.1 | 22.3 | 26 |
| Example 2 | | | | 0.96 | | | | | | | | | |
| Reference | 87.3 | 0.0190 | LiSn | 0.57 to | 13.8 | 0.0027 | 100 | 106 | 53 | 0.0217 | 24.0 | 21.0 | 24 |
| Example 3 | | | | 0.66 | | | | | | | | | |
| Reference | 92.3 | 0.0200 | Li [symbol] Bi | 0.81 to | 8.4 | 0.0017 | 80 | 79 | 43 | 0.0217 | 25.2 | 22.3 | 32 |
| Example 4 | | | | 0.83 | | | | | | | | | |
| Reference | 92.8 | 0.0202 | Li [symbol] Sb | 0.94 to | 5.2 | 0.0015 | 80 | 74 | 35 | 0.0217 | 24.9 | 22.0 | 40 |
| Example 5 | | | | 0.96 | | | | | | | | | |
| Reference | 87.3 | 0.0190 | LiSn | 0.57 to | 13.8 | 0.0027 | 80 | 77 | 41 | 0.0217 | 24.3 | 21.1 | 39 |
| Example 6 | | | | 0.66 | | | | | | | | | |
| Example 1 | 92.3 | 0.0200 | Li [symbol] Bi | 0.81 to | 8.4 | 0.0017 | 60 | [symbol] 5 | 23 | 0.0217 | 25.2 | 22.4 | 108 |
| | | | | 0.83 | | | | | | | | | |
| Example 2 | 92.8 | 0.0202 | Li [symbol] Sb | 0.94 to | 5.2 | 0.0015 | 60 | 60 | 29 | 0.0217 | 24.9 | 22.1 | 95 |
| | | | | 0.96 | | | | | | | | | |
| Example 3 | 87.3 | 0.0190 | LiSn | 0.57 to | 13.8 | 0.0027 | 60 | 62 | 33 | 0.0217 | 24.2 | 21.3 | 127 |
| | | | | 0.66 | | | | | | | | | |
| Example 4 | 92.3 | 0.0200 | Li [symbol] Bi | 0.81 to | 8.4 | 0.0017 | 20 | 1 [symbol] | 9 | 0.0217 | 24.8 | 22.0 | 105 |
| | | | | 0.83 | | | | | | | | | |
| Example 5 | 92.8 | 0.0202 | Li [symbol] Sb | 0.94 to | 5.2 | 0.0015 | 20 | 21 | 12 | 0.0217 | 25.3 | 22.4 | 90 |
| | | | | 0.96 | | | | | | | | | |
| Example 6 | 87.3 | 0.0190 | LiSn | 0.57 to | 13.8 | 0.0027 | 20 | 17 | 7 | 0.0217 | 24.0 | 21.2 | 133 |
| | | | | 0.66 | | | | | | | | | |
| Example 7 | 92.3 | 0.0200 | Li [symbol] Bi | 0.81 to | 8.4 | 0.0017 | 60 and 20 | 55 | 42 | 0.0217 | 24.7 | 22.1 | 103 |
| | | | | 0.83 | | | | | | | | | |
| Example 8 | 92.8 | 0.0202 | Li [symbol] Sb | 0.94 to | 5.2 | 0.0015 | 60 and 20 | 5 [symbol] | 49 | 0.0217 | 25.0 | 21.8 | 88 |
| | | | | 0.96 | | | | | | | | | |
| Example 9 | 87.3 | 0.0190 | LiSn | 0.57 to | 13.8 | 0.0027 | 60 and 20 | 63 | 44 | 0.0217 | 24.4 | 21.3 | 119 |
| | | | | 0.66 | | | | | | | | | |

[symbol]

indicates data missing or illegible when filed

From Table 1, it can be understood that the lithium-ion battery of the embodiment using the lithium alloy particles with the lithium-alloying potential of 0.5 V (vsLi/Li⁺) and a D90 smaller than 70 μm measured by laser diffraction and scattering method can suppress a decrease in capacitance when the lithium-ion battery is repeatedly charged and discharged.

Examples 7 to 9 had D90 similar to those of Examples 1 to 3, respectively, but had a large D50, but no significant differences in cycling properties. From this it can be seen that the smaller D50 and the smaller D90 affect the cycling properties.

What is claimed is:

1. A method for manufacturing a lithium-ion battery, the method comprising:
providing a positive electrode precursor layer containing at least a lithium alloy particle and a positive electrode active material;
providing a lithium-ion battery precursor including the positive electrode precursor layer, a separator layer, and a negative electrode active material layer in an order of the positive electrode precursor layer, the separator layer, and the negative electrode active material layer, and impregnated with an electrolyte; and
performing initial charging on the lithium-ion battery precursor to make the positive electrode precursor layer into a positive electrode active material layer, wherein the lithium alloy particle is a lithium alloy particle with a lithium-alloying potential of 0.5 V (vsLi/Li⁺) or higher, and with a particle diameter D90 smaller than 70 μm as measured by a laser diffraction and scattering method.

2. The method according to claim 1, wherein the lithium alloy particle is selected from the group consisting of Li₃Bi, Li₃Sb, and LiSn.

3. The method according to claim 1, wherein the positive electrode active material is lithium nickel cobalt manganese oxide.

4. A lithium-ion battery comprising a positive electrode active material layer, a separator layer, and a negative electrode active material layer in an order of the positive electrode active material layer, the separator layer, and the negative electrode active material layer, wherein:
the positive electrode active material layer contains at least one of a positive electrode active material, a bismuth elemental particle, and an antimony elemental particle; and
a particle diameter D90 of the bismuth elemental particle and a particle diameter D90 of the antimony elemental particle measured by a laser diffraction and scattering method are each smaller than 70 μm.
